(19) United States
(12) Patent Application Publication
(10) Pub. No.: US 2014/0317459 A1
(43) Pub. Date: Oct. 23, 2014

(54) BACKUP SYSTEM DEFECT DETECTION

(71) Applicant: Intronis, Inc., Chelmsford, MA (US)

(72) Inventors: Steven Frank, Maynard, MA (US); Neal Bradbury, Hillsdale, NJ (US); Jay Bolgatz, Litchfield, NH (US)

(73) Assignee: Intronis, Inc., Chelmsford, MA (US)

(21) Appl. No.: 14/256,338

(22) Filed: Apr. 18, 2014

Related U.S. Application Data
(60) Provisional application No. 61/813,249, filed on Apr. 18, 2013.

(51) Int. Cl. G06F 11/14

(52) U.S. Cl. CPC G06F 11/1458
USPC 714/57

(57) ABSTRACT

A backup defect detection system includes a backend and an agent. The backend includes a plurality of file servers backed by a database. The database contains data associated with one or more users. The agent is installed on a user's computing device and in communication with the backend to scan a user's selected folders to determine new or changed files and upload the new or changed files to the backend. The agent is configured to generate one or more logs recording the success or failure type of a file backup and transmit the logs to the backend. The backend is configured to generate a report from the logs, filter and prioritize the report based on a set of user defined importance for each error type and provide the filtered and prioritized report for further action. Related apparatus, systems, techniques and articles are also described.

### CROSS-REFERENCE TO RELATED APPLICATIONS

This application claims the benefit of U.S. Provisional Patent Application Ser. No. 61/813,249 filed on Apr. 18, 2013, the contents of which are hereby incorporated by reference in their entirety.

### TECHNICAL FIELD

The subject matter described herein relates to detection of defects in backup systems.

### BACKGROUND

A remote, online, or managed backup service, sometimes marketed as cloud backup, is a service that provides users with a system for the backup and storage of computer files. Online backup providers are companies that provide this type of service to end users (or clients). Such backup services are considered a form of cloud computing.

Online backup systems are typically built around a client software program that runs on a schedule, typically once a day, and usually at night while computers aren't in use. This program typically collects, compresses, encrypts, and transfers the data to the remote backup service provider's servers or off-site hardware.

### SUMMARY OF THE INVENTION

In a first aspect, a backup defect detection system in disclosed. In some embodiments, the system includes a backend and an agent. The backend includes a file server(s) backed by a database(s). The database(s) contains data associated with a user(s). The agent is installed on a user's computing device, in communication with the backend. The agent, which can be software, is structured and arranged to scan a user's selected folders to identify any new or changed files and to upload the new and/or changed files to the backend. The agent is configured to generate a log(s) recording the success type or failure type of a file backup and to transmit the log(s) to the backend. The backend is configured to generate a report from the log(s), filter and prioritize the report based on a set of user defined importance for each error type, and to provide the filtered and prioritized report for further action.

One or more of the following features may be included. The backend may include a rules engine to process the generated report based on a combination of user defined rules and predefined rules. In some variations, the agent may be adapted to alert the backend once all new files and changed files have been uploaded; to provide the backend with a number of items uploaded; and to provide the backend with a number of bytes uploaded.

In a second aspect, a computer implemented method is disclosed. In some embodiments, the method includes receiving data characterizing logs and prioritized goals. Each log is created in response to backup actions by an agent(s). Each agent is associated with a partner and each goal has an associated set of rules. Each rule includes a solution. A report is generated from the received data. The report includes backup action error occurrences and types. A subset of partners is determined who match the prioritized goals using a rules engine. Data are transmitted automatically to a partner(s). The transmitted data include an explanation of the problem and the solution as defined in the rules of a prioritized goal(s).

One or more of the following features may be included in the method. For example, the method may include prioritizing the report based on a set of user-defined importance for each failure type. Generating a report may include filtering each log of the plurality of logs. Transmitting data to a partner(s) may include transmitting an alert(s) and/or a message(s), e.g., an email, a text message, and a Tweet. Receiving data may include receiving an alert(s) and/or a message(s) from the agent that may include a number of failure errors and a number of bytes uploaded to the backend. Transmitting data may include transmitting a patch to update the agent. In some variations, the agent periodically may scan selected folders stored on an end user's computing device to identify a new file(s) and/or changed file(s). The agent may upload identified new and/or changed file(s) to a backend as part of a backup action. In some variations, the agent may add the backup action to one or more logs. In some implementations, adding the backup action to a log may include identifying which of the identified new and/or changed files were successfully backed up; identifying which of the identified new and/or changed files were backed up while causing a system warning; and identifying which of the new and/or changed files failed to be backed up. Moreover, identifying which of the identified new and changed files failed to be backed up includes identifying a failure type.

In a third aspect, articles of manufacture are disclosed. In some embodiments, articles of manufacture are also described that include computer executable instructions permanently stored (e.g., non-transitorily stored, etc.) on computer readable media, which, when executed by a computer, cause the computer to perform operations described herein. Similarly, computer systems are also described that may include a processor(s) and memory coupled to the processor(s). The memory may temporarily or permanently store a program(s) that causes the processor(s) to perform an operation(s) described herein. In addition, methods can be implemented by a data processor(s) either within a single computing system or distributed among multiple computing systems.

The subject matter described herein provides many advantages. For example, the detection of defects can be used to proactively support customers by providing a solution before they are even aware of an issue. Indeed, by proactively contacting a user, the problem is fixed quickly and provides the user with a high quality experience which will entice them to stay loyal customers. Additionally, a decrease in backup defects increases the ability of users to restore their data at any time.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 shows a system diagram of an illustrative embodiment of a data backup defect detection system;

FIG. 2 shows an illustrative example of a detailed agent backup log;

FIG. 3 shows a process flow diagram of an illustrative embodiment of a method for performing a backup;

FIG. 4 shows a bar graph showing an illustrative example report;

FIG. 5 shows a bar graph showing an illustrative example report;

FIG. 6 shows a bar graph showing an illustrative example report; and

FIG. 7 shows a process flow diagram of an illustrative embodiment of a method of automatically providing customer support in the event of backup action errors.

### DETAILED DESCRIPTION

The nature of backup appears simple at first sight: copy file from a source to a destination. However, problems arise in infinite number of user environments: from different versions of Windows, to different storage subsystems and Internet connections, and even software configuration options. There are always problems, and for an end-user manually managing even a few servers can be a daunting task, especially since one might miss the one error that lets one know a critical file was not being backed up. The current subject matter can provide information regarding exactly what account is experiencing defects and exactly how to help fix the problem.

Customers or end-users (collectively, “users”) can be organized into a hierarchical structure. “Partners” refer to any account that manages other accounts, such as a managed service provider. Each partner can have a plurality of end-user accounts. End-user accounts include specific business entities, such as, e.g., a dentist's office, a doctor's office, and so forth. Each account can have a plurality of subaccounts. A subaccount refers to each registered computing device with a backup software agent installed on the device. For example, a doctor's office may have multiple computers each having backup software and each computer being a subaccount.

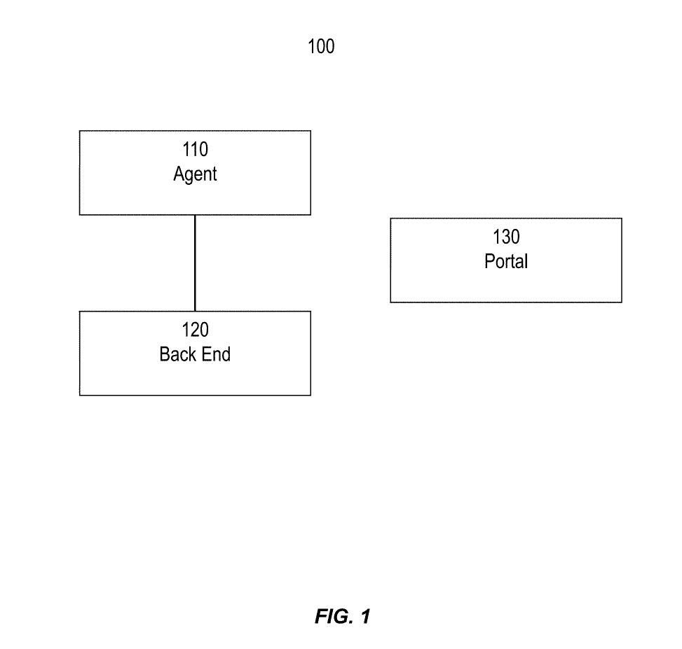

FIG. 1 is a system diagram 100 of an illustrative embodiment of a data backup defect detection system. In some embodiments, the system includes an agent 110 and a backend 120. An agent 110 is software that is installed on an end-user's computing device, e.g., a server, desktop, laptop, mobile device, tablet, and so forth (i.e., a sub-account). Although the invention will be described with the agent 110 as software, those skilled in the art can appreciate that, in the alternate, the agent 110 can be a hardwired device that is configured to perform the same function as the software. The agent 110 is configured to periodically scan through the subaccount's selected folders looking for new or changed files and to perform a backup action by uploading any new or changed files to a backend 120. For every backup-action the agent 110 performs, the agent 110 is further adapted to update one or more logs with information related to which files were successfully backed up, which files were backed up but caused system warnings, and which files failed to backup. Each failure includes a failure type, e.g., “file not found,” “file access denied,” and so forth. Advantageously, in operation there can be a plurality of agents (subaccounts associated with accounts and partners) operating independently.

A backend 120 includes a number of file servers exposed through application servers. The application servers are backed by at least one database. The database includes data associated with the agent 110 as well as the user's data files, which is to say, the backed up data). The agent 110 is in communication with the backend 120 and can store the backup logs on the backend 120.

In addition to storing backup logs, the backend 120 is configured to generate a report from the logs then filter; to prioritize the report based on a set of user defined importance for each error type; and to provide the filtered and prioritized report for further action.

A portal 130 is a website that a user can log into to manage their data and view their backup history. Backups can be controlled, e.g., via the portal 130, thus enabling remote management of the agent 110.

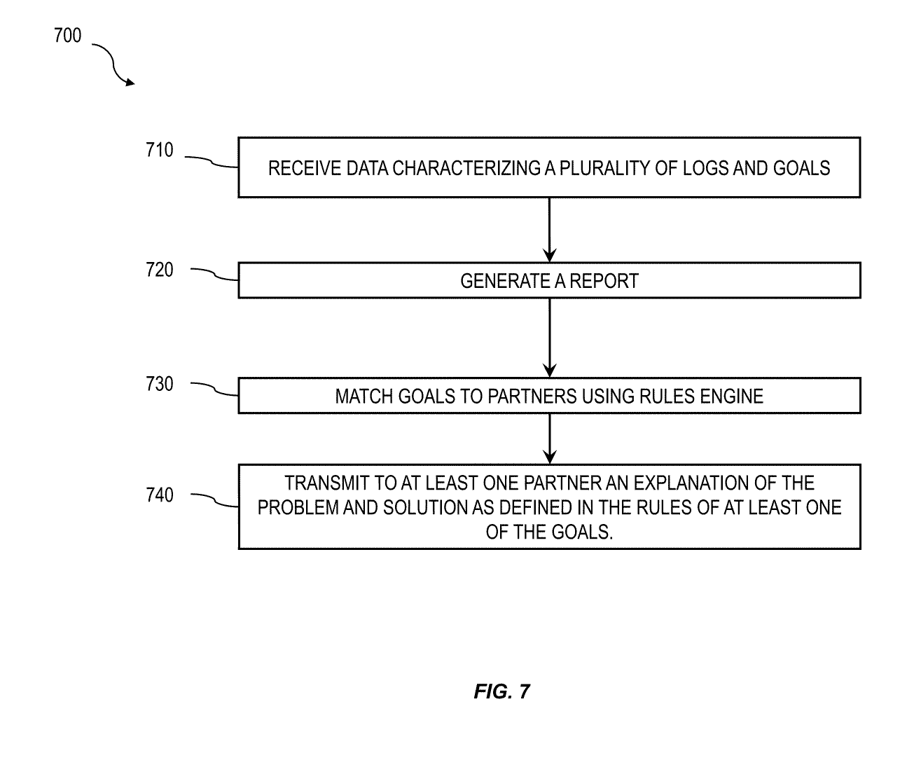

FIG. 7 shows a process flow diagram 700 of an illustrative embodiment of a method of automatically providing customer support in the event of backup action errors. At 710, the backend 120 receives data characterizing a plurality of logs and prioritized goals. One or more agents create each log in response to a plurality of backup actions. Each goal includes a set of rules and each rule defines a problem and a solution. The subaccount, account, partner, or backend 120 can define rules. At 720, a report is generated from the received data. At 730, the backend 120 can determine a subset of partners who match the prioritized goals using a rules engine and the received rules. At 740, the backend 120 can automatically transmit, to at least one partner, data including an explanation of the problem and the solution as defined in the rules of at least one of the prioritized goals. In addition or as an alternative, the backend 120 can automatically transmit, to at least one partner, data including a patch to update software on the agent 110 for automatic installation by the agent 110. In this manner, the agent 110 can receive and implement the solution automatically before the account, subaccount, or partner even knows a defect exists.

The transmission of data can include an automatically generated alert or message (e.g., an email, a text message, a Tweet, and the like). Although the following discussion will refer specifically to an email alert or an email message, the invention is not to be construed as being so limited. The email can include the description of the problem and a solution to the problem. However, some partners, accounts, and subaccount users may respond with more specific questions or responses. Limiting the number of emails automatically generated over a time period can prevent receiving more responses than can be handled. To maximize the effectiveness of the limited emails, goal selection can be important. For example, goals can reflect if a specific data set type currently has the most problems, if a data set is critical to a user, and if a particular partner pays a higher rate for backup service or has a sufficiently large user base. For example, a rule can specify that an email be sent to all partners who have an annual contract over $50,000 for a year of service and send at most 50 emails. Additionally, subaccounts can be clustered based on their associated account or partner and a single email can be automatically generated for each cluster.

Logs can comprise basic and detailed logs. For example, a basic log can include the following fields:
Customer ID—A unique identifier for the customer;
Computer OS—Windows XP, Vista, 7, 2003, 2008, and the like;
Backup Set Name/Type; Name—A unique name assigned by the customer, such as “Quickbooks;”
Type—Files/Folder, Exchange, SQL, VMware, and the like;
Backup Date—The date the backup started, both our time, and the customer's local time;
Backup Runtime—How long the backup ran for;
Is Local Only—Is the backup only going to a local storage system;
Number of Errors produced by backup;
Number of Warnings produced by backup;
Number of Items in Set—Based on backup set type, can represent the number of items the backup set's selection matched, such as number of files, or number of databases;
Number of Items Backed Up; and
Number of Bytes Backed Up;

For example, a detailed log can include the following fields:
Log Level—info, warning, error, exception, debug;
Flags—aid parsing logs for specific entries that relate to success, error or warnings;
Timestamp—a timestamp for an action;
Function—a function of the code the backup was logged in;
Component—a plug-in the backup is for (File, Exchange, SQL, VMware);
Action ID—a unique Action ID; String Const—aids in translating a log entry for display; and
Params—parameters including filenames, file sizes, and error codes.

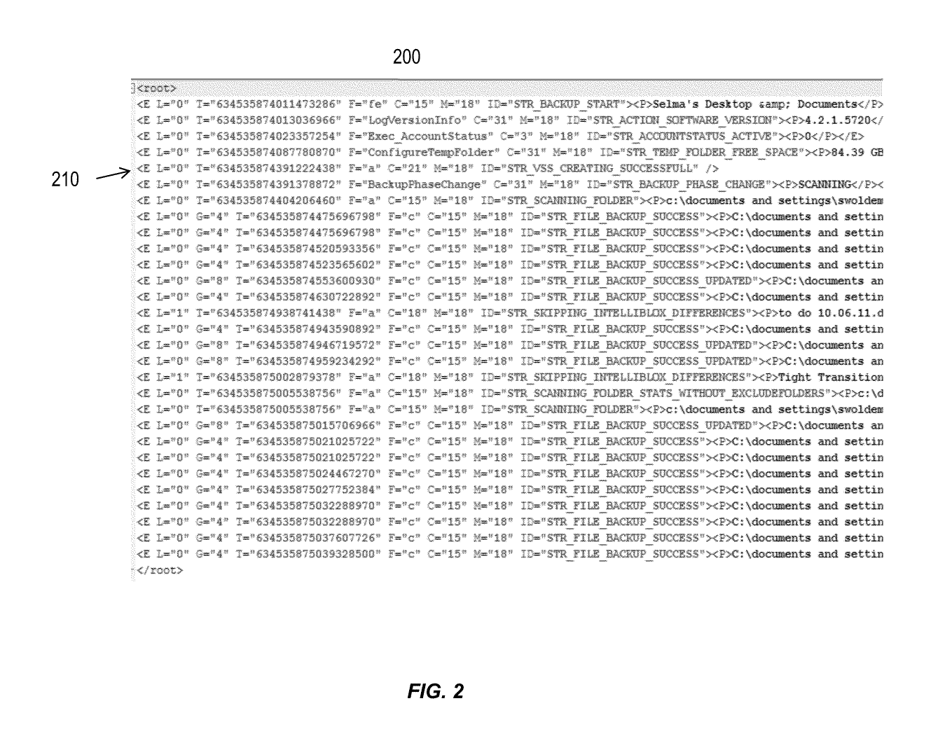

FIG. 2 shows an illustrative example of a detailed agent backup log 200. The log contains data related to the above-mentioned fields. For example, line 210 in the backup log 200 includes an entry to Log Level (“L=0”), Timestamp (“T=63457 . . . ”), Flag (“F=a”), Component (“C=21”), and Action ID (“ID=‘STR_VSS_CREATING_SUCCESSFULL’”). The detailed agent backup log can include additional information. The basic agent backup log and the detailed agent backup log can be combined into one log.

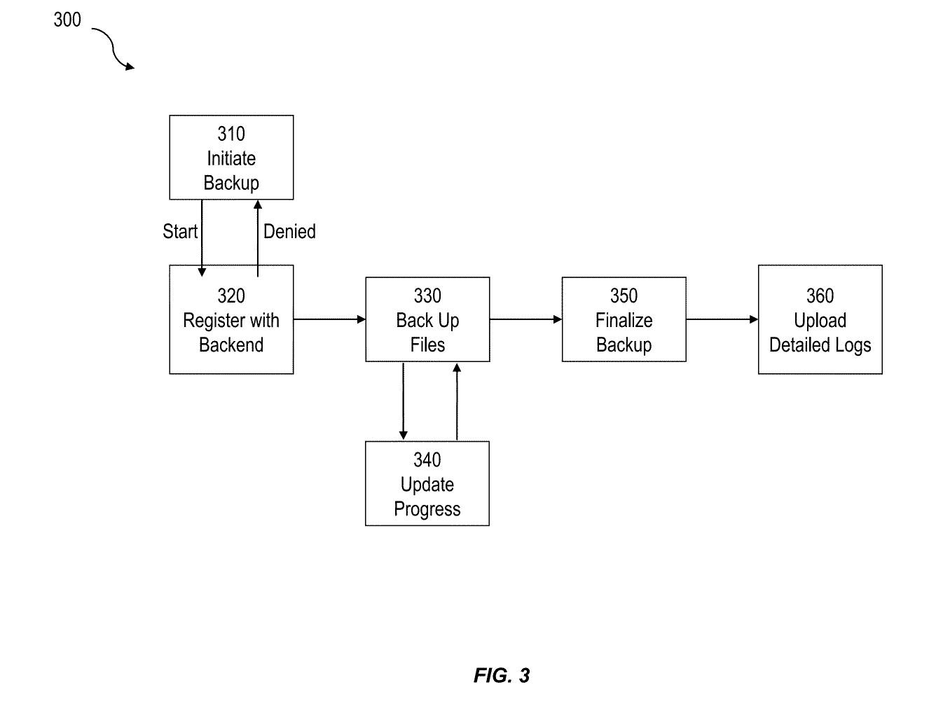

FIG. 3 shows a process flow diagram 300 of an illustrative method for performing a backup. At 310 a backup is initiated. A backup can be initiated automatically in response to an event (e.g., a scheduler implementing a periodic backup) or can be manually initiated. The backup can be initiated by the agent 110 or the backend 120. At 320, the backup registers with the backend 120. The backup can be denied for business reasons, such as a non-paying account. At 330, files specified by the subaccount are uploaded by the agent 110 to the backend 120. During the backup step, the backup progress can be periodically updated at step 340. Once all data have been uploaded, at 350 the agent 110 finalizes the backup by alerting the backend 120 that all files are uploaded. The agent 110 further sends information, such as the number of errors and warnings, the number of items uploaded, and the number of bytes uploaded (i.e. the basic log) to the backend 120. At 360, the detailed logs are uploaded from the agent 110 to the backend 120.

The logs can be accumulated over, for example, a week-long time period, and a query can be run against the logs to generate a report. The report can be based on conditions that the user sets for their own alerts. For example, if a user considers a canceled backup as a failure, then each canceled backup can be included in the report. The reports can be filtered for specific failed actions and/or conditions when failures occurred. The entries in the report can be prioritized based on a set of user defined importance for each error type. The report can be prioritized by error count; however, error count is not always an indication of the seriousness of a defect. For example, a file system backup can result in 10 errors while successfully backing up 100,000 files yet an exchange backup can only result in one error and the entire backup will fail. Therefore, instead of always prioritizing by error count, the user can define prioritized backup set types and the report can be prioritized based on those types. In this manner, the defect detection can be tailored to the user's needs and result in the detection of critical (to the user) failures.

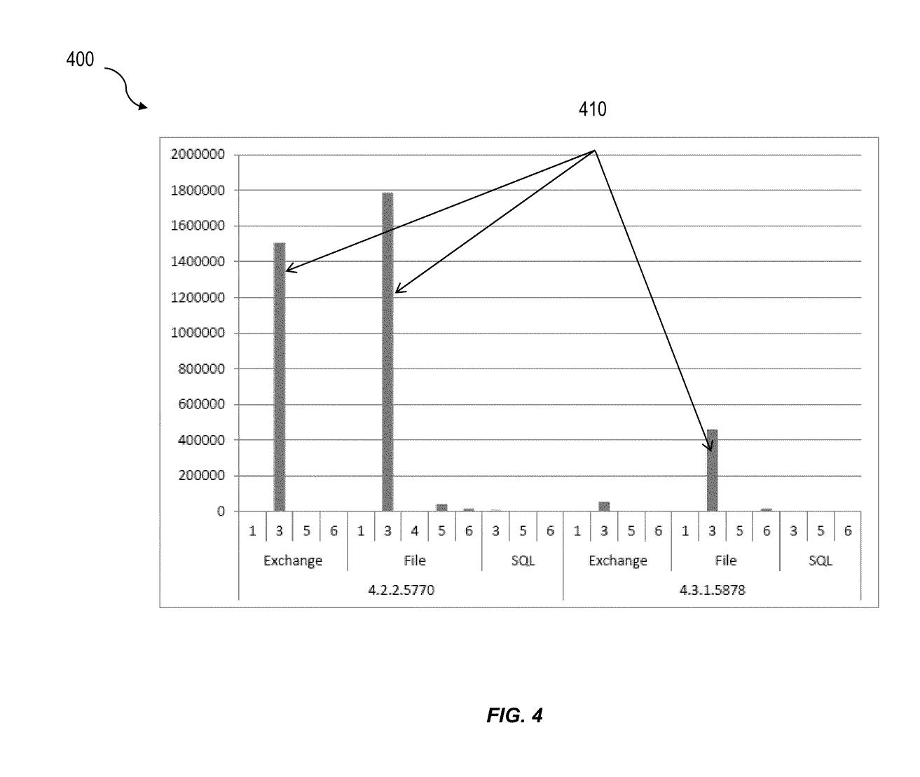

FIG. 4 shows a bar graph 400 showing an example report (displayed graphically for the purpose of illustration) of error count organized by agent version, plugin, and backup status. It can be seen at 410 that backups from file systems have the largest error count. In this situation, the data could then be aggregated by user and filtered by a specific version and plugin.

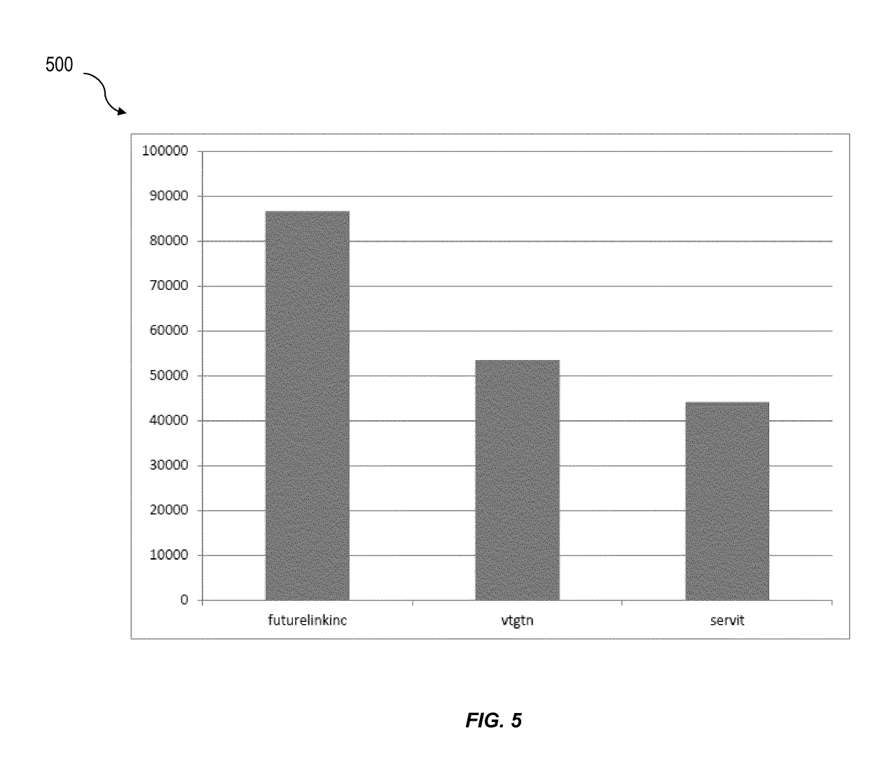

FIG. 5 shows a bar graph 500 showing the example report of FIG. 4 (displayed graphically for the purpose of illustration) filtered by partners and prioritized by error count. The account for specific partners can then be analyzed.

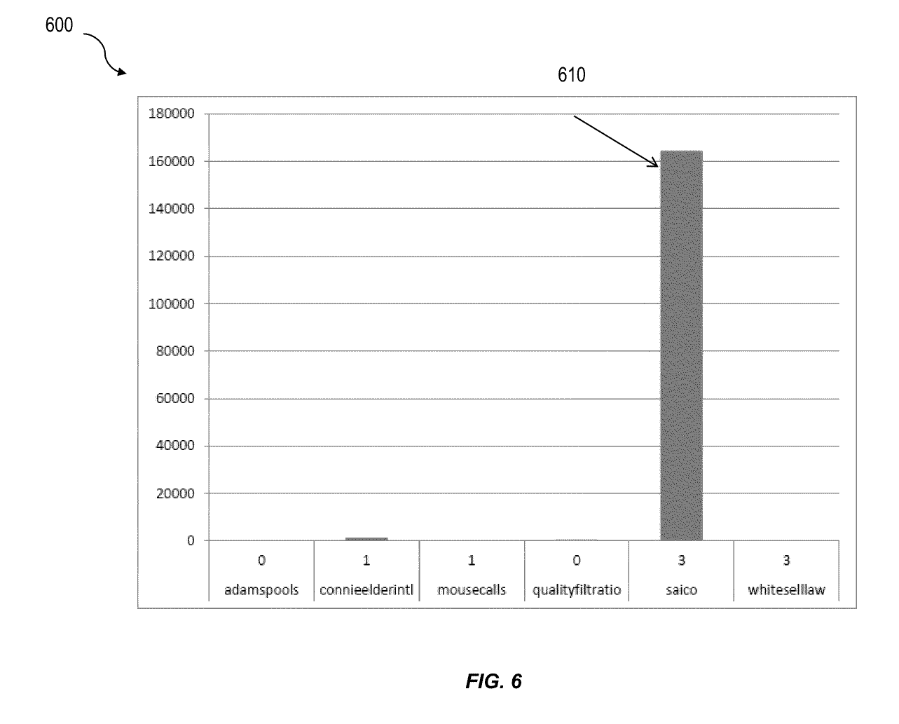

FIG. 6 shows a bar graph 600 showing an example report (displayed graphically for the purpose of illustration) filtered by agents for a particular partner. From the example of FIG. 6 it can be determined that one agent (i.e., soico) is producing the majority of errors. The detection can be provided for further action. Further action can include contacting the user, updating the agent and/or backend software to address detected software deficiencies.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, the logic flow depicted in the accompanying figures and described herein do not require the particular order shown, or sequential order, to achieve desirable results. Other embodiments may be within the scope of the following claims.

What is claimed is:

1. A backup defect detection system comprising:
a backend including a plurality of file servers backed by a database, the database containing data associated with one or more users;
an agent installed on a user's computing device and in communication with the backend and adapted to scan a user's selected folders to identify at least one of a new file and a changed file and to upload the identified new file or changed file to the backend, the agent configured to generate one or more logs recording at least one of a success type and a failure type of a file backup and to transmit the logs to the backend;
wherein the backend is configured to;
generate a report from the logs;
filter and prioritize the report based on a set of user defined rules for each error type; and
provide the filtered and prioritized report for further action.

2. The backup defect detection system of claim 1, wherein the backend includes a rules engine to process the generated report based on a combination of user defined rules and predefined rules.

3. The backup defect detection system of claim 1, wherein the agent includes software.

4. The backup defect detection system of claim 1, wherein the agent is adapted to perform at least one of the following:
alert the backend once all new files and changed files have been uploaded;
provide the backend with a number of items uploaded; and
provide the backend with a number of bytes uploaded.

5. A computer implemented method comprising:
receiving data characterizing a plurality of logs and a plurality of prioritized goals, each log created in response to a plurality of backup actions by one or more agents, each agent associated with a partner, and each prioritized goal having an associated set of rules, each rule including a solution;
generating a report from the received data, the report including backup action error occurrences and error types;
identifying a subset of partners who match the prioritized goals using a rules engine; and
transmitting data automatically to at least one partner from the subset of partners, the transmitted data including an explanation of a backup failure problem and a solution to the backup failure problem as defined in the rules of at least one prioritized goal.

6. The method of claim 5 further comprising the agent periodically scanning selected folders stored on an end user's computing device to identify at least one of one or more new files and one or more changed files.

7. The method of claim 5 further comprising adding the backup action to one or more logs.

8. The method of claim 7, wherein adding the backup action to one of more logs includes:
identifying which of the identified new and changed files were successfully backed up;
identifying which of the identified new and changed files were backed up while causing a system warning; and
identifying which of the new and changed files failed to be backed up.

9. The method of claim 8, wherein identifying which of the identified new and changed files failed to be backed up includes identifying a failure type.

10. The method of claim 5, wherein generating a report includes filtering each log of the plurality of logs.

11. The method of claim 5 further comprising prioritizing the report based on a set of user-defined importance for each failure type.

12. The method of claim 5, wherein transmitting data to at least one partner includes transmitting at least one of an alert and a message.

13. The method of claim 12, wherein the at least one of an alert and a message is selected from the group consisting of an email, a text message, and a Tweet.

14. The method of claim 5, wherein receiving data includes receiving from the agent at least one of:
a number of failure errors; and
a number of bytes uploaded to the backend.

15. The method of claim 5, wherein, transmitting data includes transmitting a patch to update the agent.
